(19) United States
(12) Patent Application Publication
(10) Pub. No.: US 2015/0198371 A1
(43) Pub. Date: Jul. 16, 2015

(54) REFRACTORY CERAMIC GAS PURGING PLUG AND A PROCESS FOR MANUFACTURING SAID GAS PURGING PLUG

(71) Applicant: REFRACTORY INTELLECTUAL PROPERTY GMBH & CO. KG, Wien (AT)

(72) Inventors: Michael Pellegrino, Munster, IN (US); Bernd Grune, Graz (AT); Gerhard Mohr, Urmitz (DE); Jennifer Suss, Kehrig (DE); Andreas Bender, Freudenberg (DE)

(21) Appl. No.: 14/423,840

(22) PCT Filed: Aug. 6, 2013
(86) PCT No.: PCT/EP2013/066486

§ 371 Date: Feb. 25, 2015

(30) Foreign Application Priority Data
Sep. 20, 2012 (EP) 12185223.0

(51) Int. Cl. F27D 3/16; B05D 1/12; C21C 5/46; B05D 1/36; B22D 41/00; C21C 5/34

(52) U.S. Cl. CPC F27D 3/16; B22D 41/00; C21C 5/34; C21C 5/46; B05D 1/36; B05D 1/12

(57) ABSTRACT

The invention relates to a refractory ceramic gas purging plug, with a gas inlet at a first end, the so-called cold end, a gas outlet at a second end, the so-called hot end, and a peripheral surface extending between first and second end.

The invention relates to a refractory ceramic gas purging plug, with a gas inlet at a first end, the so-called cold end, a gas outlet at a second end, the so-called hot end, and a peripheral surface extending between first and second end.

A gas purging plug of this generic design is well known in prior art and used since long in metallurgical melting and treatment vessels such as a ladle (German: Pfanne), Tundish (German: Verteiler) or a converter (German: Konverter).

The general shape of such a gas purging plug depends on its use. The following shapes are the most common ones: cylindrical, frustoconical, cubic.

Gas, introduced at the cold end, must flow through or along the ceramic part of the plug before it escapes via the hot end into an adjacent molten metal (metal melt).

The ceramic part therefore is either provided with random porosity (German: ungerichtete Porosität) or directed porosity (German: gerichtete Porosität). The random porosity is achieved by a sponge like structure of the refractory ceramic body, the directed porosity by channels, slits, holes or the like, running through a more or less dense ceramic body.

Especially in cases of random porosity, but not limited to this embodiment, there is a risk of gas diffusing in an uncontrollable manner via the peripheral surface of the ceramic body, even though the purging device typically is installed (mortared) in a well block (German: Lochstein) and/or within a ceramic refractory lining along the bottom or wall of the corresponding metallurgical vessel.

For this reason the peripheral surface of the ceramic part of the ceramic body is covered by a metal casing, which is impermeable to the gas transported through the plug, but these plugs do have several disadvantages:

Installation of such a plug in a bottom or wall lining of a metallurgical vessel or in a well nozzle (well block) is performed by using a mortar in between the corresponding two parts to achieve a fixed seat of the plug, but the mortar doesn't always stick well on the metal case with the consequences of loss of mortar or an incomplete mortar layer between the respective parts.

Another disadvantage of these metal cased plugs is their reduced refractoriness in use. In this respect the metal casing is the weakest part, meaning that the metal casing has the lowest melting temperature. Thus, during use, i.e. under severe temperature load, which typically reaches far more than 1,000° C., the metal casing gradually disintegrates.

The metallurgical attack during plug use worsens this disintegration. When the purging device (the gas purging plug) is cleaned with an oxygen blowing lance, temperatures of more than 1300° C. are reached, and are responsible for a rapid increase of the wear of said metal casing and the formation of gaps between the plug and the surrounding refractory material.

It is an object of the invention to avoid these disadvantages and to provide a gas purging device of any shape with a longer service time, even under harsh conditions.

The invention maintains the use of a gas purging plug with an outer metal casing, in order to guide the gas in the desired way through the plug and to avoid lateral gas diffusion, but applies a thin additional layer onto the outer surface of the metal casing.

This layer covers the surface of the metal casing at least partially, comprises a refractory material, and exhibits the following properties and advantages:
It adheres well to the outer surface of the metal casing
It protects the metal casing against metallurgical attack
It protects the metal casing against excessive heat
It harmonizes with the surrounding refractory material of the well block, wall or bottom lining of the metallurgical surface
It allows chemical reactions with the metal casing under heat, thus increasing the temperature resistance of the metal casing
It avoids excessive wear of the metal casing
It allows chemical reactions with the surrounding refractory material, thus improving the refractoriness of this material
It provides a better bonding service for any repair material applied to a replacement plug exposed above the well block

In its most general embodiment the invention relates to a refractory ceramic gas purging plug featuring the following characteristics:
a gas inlet at a first end,
a gas outlet at a second end, and
a peripheral surface extending between first and second end,
which peripheral surface being at least partially covered by a metal casing, wherein
said metal casing has a refractory coating, which extends at least partially along its outer surface.

In the following possible variations and embodiments of this general technical concept are disclosed which may be realized either individually or in arbitrary combinations, if technically reasonable and not explicitly excluded.

The refractory coating should be as thin as possible to enable a good adherence and to avoid wear by mechanical abrasion.

According to various embodiments the thickness should be <2.5 mm, <1 mm or even <0.5 mm, wherein thickness being defined as the thickness of the layer in a direction perpendicular to the corresponding surface section of the metal casing. This does not exclude individual particles (grains) of extending above this “thickness”.

A refractory coating with which the refractory grains protrude the adhesive (the lacquer) has the advantage of a certain roughness and an improved assemblage with the surrounding refractory material of the corresponding vessel lining. The metal surface, regardless of its original surface finish, is covered with a thin emery-paper like layer with excellent physical and chemical properties.

According to one embodiment the refractory layer, depending on its grains size, should feature a minimum of 5 or 9 or 20 or 27 or 36 grains per square cm, meaning those grains which protrude the basic adhesive (the lacquer). The maximum number of grains per square centimeter can be set at 400 or 380 or 361 or 270 or 215 or 155 or 81.

Good results may be achieved when the refractory protective layer comprises a lacquer coat with a thickness less than 1.0 mm or less than 0.5 mm or less than 0.3 mm or less than 0.2 mm.

The term lacquer includes any and all types of liquid materials adhering to the outer surface of the metal casing and having a suitable temperature resistance. One example is a resin based lacquer, for example a novolak resin. Other examples are: polysiloxane, sodium silicate, phenolic resin, melamine resin.

This lacquer coat may be doped with discrete refractory grains, meaning the refractory coating is made of the liquid lacquer and refractory grains, wherein the refractory grains may protrude the lacquer coat. In other words:

The lacquer serves as an adhesion promoting agent between the metal casing and the refractory grains, especially as applied separately.

This is the reason why the overall thickness of the protective layer may be very thin, with all the advantages deriving therefrom as mentioned above.

The refractory grains may also be applied as a mixture together with the lacquer.

The advantages disclosed above may be enhanced by a specific selection of the refractory component of the protective cover: The discrete refractory grains may derive from refractory oxides, carbides, nitrides, spinels and comprise: MgO, Al₂O₃, ZrO₂, SiO₂, Cr₂O₃, SiC, forsterite (M₂S), mullite (A₃S₂), TiO₂, calcium aluminate and others.

A particular advantage may be achieved with a refractory coating material which reacts under temperatures above 800° C. with the material of the metal casing (envelope) thereby forming a chemical compound with a melting temperature above 1,300° C., for example compounds of MgO and/or Al₂O₃ (from the grains) and iron oxide (from the metal casing).

According to a further embodiment the refractory coating comprises a material which reacts under temperatures above 800° C. with the material of the metal casing, thereby forming a spinel with a melting temperature above 1,300° C. This spinel may be an MgFe spinel or an AlFe spinel like a hercynite spinel (with a melting temperature of 1780° C.). This provides the following further advantage: During spinel formation the material expands, which leads to an improved fixation of the plug within its surrounding.

Further melting of the material of the metal casing and/or wear by flashing during oxygen lance treatment (cleaning) is at least reduced if not excluded.

The same is true with respect to the surrounding refractory material, which may provide as well a longer service time and any erosion between plug and the surrounding refractory lining is reduced or avoided respectively. The refractory behaviour of mortars with low refractoriness, for example ready-to-use sodium silicate mortars, is also improved.

The invention further discloses a process for manufacturing such a gas purging device.

This process includes the following steps, starting with a known purging plug (purging device) of any shape which comprises an outer metal envelope (casing):
a) applying a liquid lacquer onto at least part of the outer surface of the metal casing of the gas purging plug and forming a liquid lacquer coat thereon,
b) applying refractory grains into the liquid lacquer coat,
c) drying of the liquid lacquer coat until it forms a hardened refractory coating together with the refractory grains.

The liquid layer has the task to provide an adhesive onto the outer surface of the metal casing for the refractory grains, which are applied after said step a) onto and into the said lacquer layer.

In an alternative said steps a) and b) are merged, meaning that the lacquer applied onto the metal casing, already includes the said refractory grains.

In general the lacquer and/or the refractory grains may be applied by either of the following technologies, known as such, but for other purposes and insofar not further described hereinafter: spraying, flooding, brushing, dipping.

With both technologies the refractory grains will stick on and in and adhere to the lacquer layer and remain there until the lacquer has hardened.

In the case of a resin based lacquer no further assistance is needed in step c) as the resin will harden by itself after application. This step may be accelerated by a heat treatment like a tempering, for example at temperatures above 50° C., >100° C. or >250° C. until the protective cover is firmly attached onto the metal coating.

The invention is now described by way of an example according to the attached drawing, showing schematically in:

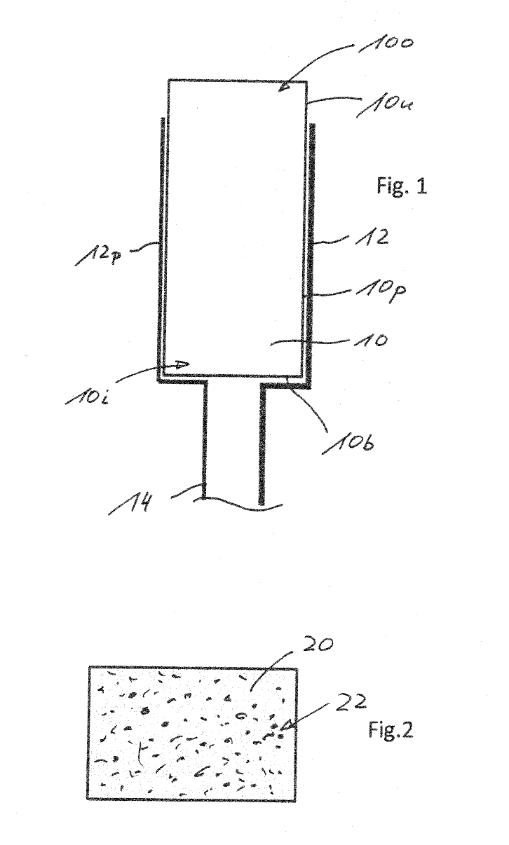

FIG. 1: a gas purging plug according to the invention in a longitudinal sectional view

FIG. 2: schematic plain view on a section of said refractory plug.

The plug comprises:

A ceramic refractory part 10 with random porosity. Part 10 is encapsulated by a metal casing 12, which surrounds the peripheral surface 10p of part 10, except for its upper end 10u, as well as part of its bottom 10b and continues into a gas feeding pipe 14, protruding downwardly from bottom 10b.

A gas is introduced via said feeding pipe section 14, flows via its first end 10i, the gas inlet end, through part 10 and leaves said part 10 at its second end 10o, the gas outlet end.

In reality there is no gap between ceramic part 10 and casing 12. This is only illustrated for a better distinction between both parts 10, 12.

That section 12p of metal casing 12 surrounding surface 10p of part 10 is covered by a refractory layer 20 made of a novolak resin, having a thickness of 0.2 mm and was applied to said surface section 12p by spraying.

Refractory grains 22 of irregular shape, made of alumina (Al₂O₃), were sprayed onto the still sticky resin layer and thus integrated into this resin layer. The grains have a size (diameter) d₉₀ of 0.5 mm to achieve the desired roughness of the refractory coating (d₉₀ means: 90 w.-% of the grains have a smaller size than said d₉₀).

After hardening of the resin, those grains with a minimum dimension of 0.2 mm will still protrude the resin layer and give the refractory layer the appearance of an emery paper.

This may be seen from FIG. 2, which is a schematic plain view on a section of said refractory coating.

During use of the gas purging plug, i.e. under temperature load, the said alumina grains will react with iron oxide (Fe²⁺) from the metal casing 12 and form a hercynite spinel, thus making the casing 12 more heat and wear resistant than in its native state.

1. Refractory ceramic gas purging plug with a gas inlet at a first end (10i), a gas outlet at a second end (10o) and a peripheral surface (10p) extending between first and second end (10i, 10o), which peripheral surface (10p) being at least partially covered by a metal casing (14), wherein said metal casing (14) features a refractory coating (20), which extends at least partially along its peripheral surface (10p).

2. Gas purging plug according to claim 1, wherein the refractory coating (20) has a thickness<2.5 mm.

3. Gas purging plug according to claim 1, wherein the refractory coating (20) has a thickness<1.0 mm.

4. Gas purging plug according to claim 1, wherein the refractory coating (20) has a thickness<0.5 mm.

5. Gas purging plug according to claim 1, wherein refractory coating (20) is made of a material which reacts under temperatures above 800° C. with the material of the metal coating, thereby forming a chemical compound with a melting temperature above 1,300° C.

6. Gas purging plug according to claim 1, wherein the refractory coating (20) is made of a material which reacts under temperatures above 800° C. with the material of the metal coating, thereby forming a spinel with a melting temperature above 1,300° C.

7. Gas purging plug according to claim 1, wherein the refractory coating (20) comprises a lacquer coat with a thickness of less than 0.5 mm.

8. Gas purging plug according to claim 7, wherein the lacquer coat is made of a resin based lacquer.

9. Gas purging plug according to claim 7, wherein the refractory coating (20) comprises discrete refractory grains (22), protruding the lacquer coating.

10. Gas purging plug according to claim 1, wherein the refractory coating (20) comprises discrete refractory grains of the group comprising: MgO, Al₂O₃, ZrO₂, spinel, SiO₂, Cr₂O₃, SiC.

11. Process for manufacturing a gas purging plug, the plug including a gas inlet at a first end (10i), a gas outlet at a second end (10o) and a peripheral surface (10p) extending between first and second ends (10i, 10o), which peripheral surface (10p) is at least partially covered by a metal casing (14), wherein the metal casing (14) has a refractory coating (20) which extends at least partially along its peripheral surface (10p), comprising the following steps:
a) applying a liquid lacquer onto at least part of the outer surface of metal casing of the gas purging plug and forming a liquid lacquer coat thereon,
b) applying refractory grains into the liquid lacquer coat,
c) drying of the liquid lacquer coat until it forms a hardened refractory coating together with the refractory grains.

12. Process according to claim 11, wherein step a) is performed by spraying the liquid layer onto the outer surface of the metal casing.

13. Process according to claim 11, wherein step b) is performed by spraying the refractory grains into the liquid coat.

14. Process according to claim 11, wherein step c) is performed under a temperature above 50° C.
